(19) United States
(12) Patent Application Publication
(10) Pub. No.: US 2021/0097508 A1
(43) Pub. Date: Apr. 1, 2021

(54) SYSTEM AND METHOD FOR CREATING, TRACKING, AND TRANSFERING NON-FUNGIBLE TOKENS IN THE ETHEREUM BLOCKCHAIN

(71) Applicant: Sean Papanikolas, Mill Valley, CA (US)

(72) Inventor: Sean Papanikolas, Mill Valley, CA (US)

(21) Appl. No.: 17/061,254

(22) Filed: Oct. 1, 2020

Related U.S. Application Data
(60) Provisional application No. 62/909,054, filed on Oct. 1, 2019.

(51) Int. Cl. G06Q 20/06; G06F 16/27

(52) U.S. Cl. CPC G06Q 20/06; G06F 16/27

(57) ABSTRACT

A method for creating a large number of non-fungible tokens on the Ethereum blockchain, wherein the method includes the steps of determining the number of tokens to create in a batch, minting a batch of non-fungible tokens by identifying a token identifier of the first token in the batch (the FROM value) and the last token in the batch (the TO value), emitting a single event for the creation of the batch of non-fungible tokens, and saving the event in an ownership database that is external to the blockchain in order to determine ownership of tokens in the Ethereum blockchain.

### BACKGROUND

### Description of Related Art

Digital assets may be stored in non-fungible tokens (NFTs) and then recorded in a blockchain which is an incorruptible digital ledger. For example, NFTs may be stored in Ethereum which is a distributed public blockchain network. In the Ethereum blockchain, miners work to earn ether, a type of crypto-token that fuels the network. A second type of token that is used to pay miners fees for including transactions in their block is called gas.

Ethereum is a cryptocurrency platform and functions as a decentralized open source blockchain that features smart contract functionality. Ether is the cryptocurrency generated by Ethereum miners as a reward for computations performed to secure and add blocks to the blockchain. Ethereum serves as the platform for many different cryptocurrencies and tokens.

Ethereum also provides a decentralized replicated virtual machine, known as the Ethereum Virtual Machine (EVM), which may execute scripts using an international network of public nodes. “Gas”, which is payable in ether, is the internal transaction pricing mechanism, and is used to mitigate transaction spam and allocate resources on the network.

As a result of an exploitation of a since-corrected flaw in the smart contract software, Ethereum was split into two separate blockchains in 2016. The new separate version became Ethereum (ETH) with the theft reversed, and the original chain continued as Ethereum Classic (ETC).

Ether is a fundamental token for operation of Ethereum, which thereby provides a public distributed ledger for transactions. It is used to pay for gas, a unit of computation used in transactions and other transitions.

The subject of gas is important to understand because gas refers to the fee, or pricing value, required to successfully conduct a transaction or execute a contract on the Ethereum blockchain platform. Priced in sub-units of the cryptocurrency ether, gas is used to allocate resources of the EVM so that decentralized applications such as smart contracts can self-execute in a secured fashion.

The exact price of the gas is determined by the network's miners, who can decline to process a transaction if the gas price does not meet their threshold. Having a separate unit for gas allows maintaining a distinction between the actual valuation of the cryptocurrency, and the computational cost.

The concept of gas was introduced to keep a distinct value that solely indicates the consumption toward computational expenses on the Ethereum blockchain network. Having a separate currency unit allows maintaining a distinction between the actual valuation of the cryptocurrency, and the computational cost. A “Gas limit” refers to the maximum amount of gas (or energy) that a party is willing to spend on a particular transaction. A higher gas limit means that more work must be done to execute a transaction using ether or a smart contract.

Ethereum implemented a standard API for NFTs within smart contracts. Ethereum had to consider use cases of NFTs being owned and transacted by individuals as well as consignment to third party brokers, wallets, and auctioneers. NFTs may represent ownership over digital or physical assets. For example, physical property such as houses or unique artwork, virtual collectables such as unique pictures of kittens or collectable cards, as well as “Negative value” assets such as loans, burdens, and other responsibilities.

A standard interface enables applications to work with any NFT on Ethereum. However, it was determined that earlier token standards were insufficient for tracking non-fungible tokens because each asset is distinct and non-fungible, whereas each of a quantity of tokens is identical or fungible.

An earlier token standard is defined as ERC-20. The ERC-20 token is a piece of code uploaded to the Ethereum blockchain, that is formatted and structured in a universal manner, that has been voted on and accepted by the community as an ERC standard. This code holds a balance of every user who uses the contract, which represents their internal token balance. However, this type of token is not sufficient for a blockchain platform where every token is unique.

Thus, Ethereum used a new token standard called ERC-721 for tracking unique digital assets. One of the biggest use cases currently for such tokens is digital collectibles, as the infrastructure allows for users to prove ownership of scarce digital goods.

Thus, ERC-721 is a standard interface used to create, track and manage non-fungible tokens in the Ethereum blockchain. Due to limitations of the Ethereum blockchain (or any system that has limitations, in this case “gas” and transaction timeouts) it is not easy to create just a few numbers of NFTs at a time.

ERC-721 may be referred to as a contract interface. In the case of Ethereum, ERC-721 is the token type for collectibles. In ERC-721, each token is completely unique and non-interchangeable with other tokens, and thus non-fungible. NFTs allow developers to tokenize ownership of any arbitrary data, drastically increasing the design space of what can be represented as a token on the Ethereum blockchain.

The ERC721 standard outlines a set of common rules that all tokens may follow on the Ethereum network to produce expected results. Token standards primarily stipulate the following characteristics about a how token ownership is decided, how are tokens created, how are tokens transferred, and how are tokens burned.

Every transaction or smart contract executed on the Ethereum blockchain requires gas. Gas is in essence a transaction fee and is only a fraction of an Ethereum token and is used by the smart contract to pay the miners securing that transaction on the blockchain for their efforts.

For example, a contract or transaction on Ethereum may be worth 50 ether, and the gas price to process this transaction at that particular time might be 1/100,000e.

An appropriate amount of gas must be used to pay for the transaction; if the amount of gas is too low, the transaction does not occur since miners do not receive enough compensation and abandon the job. Using gas high and low limits, developers can make sure that their smart contracts run reliably over the network. This is done by paying the miners enough compensation while not losing the extra gas they pay for the transaction that would otherwise be lost to the miners after the transaction is secured.

The gas system prioritizes important transactions first by making their computational costs and rewards publicly known to the miners. This adds an extra level of fairness and justice to the blockchain, making sure that all contributors involved in the security and maintenance of the blockchain are given clarity on the risks and rewards of their contributions.

An issue with Ethereum thus remains that it is difficult to create more than one or just a small amount of NFTs at a time because of limitations of gas. The prior art suggests that creating multiple NFTs might be as simple as using a simple loop in an algorithm.

For example, consider the problem of wanting to create or mint 100 NFTs at one time. This might be done by creating a loop that iterates 100 times to obtain 100 NFTs. Unfortunately, each loop iteration on the Ethereum blockchain costs gas, which costs money. Using the loop method, the process will eventually run out of gas, thus making it impossible to create more NFTs. Thus, it is not possible to create, search, or modify a large number of NFTs in a linear fashion, or in O(n) time.

Accordingly, it would be an improvement of the state of the art to provide a method for creating multiple NFTs at one time while adhering to the ERC-721 specification. It would also be an improvement to provide a system for tracking ownership of NFTs that does not store ownership data in the blockchain itself but uses an external system to thereby reduce computational costs.

### BRIEF SUMMARY

The present invention is a method for creating a large number of non-fungible tokens on the Ethereum blockchain, wherein the method includes the steps of determining the number of tokens to create in a batch, minting a batch of non-fungible tokens by identifying a token identifier of the first token in the batch and the last token in the batch, emitting a single event for the creation of the batch of non-fungible tokens, and saving the event in an ownership database that is external to the blockchain in order to determine ownership of tokens in the Ethereum blockchain.

In a first aspect of the invention, a method is provided for performing batch minting of NFTs in a single event without incurring large transactional gas costs.

In a second aspect of the invention, ownership of NFTS is stored external to the Ethereum blockchain in a traditional database to thereby reduce costs.

In a third aspect of the invention, a Fenwick tree may be used to track ownership of NFTs.

In a fourth aspect of the invention, events emitted upon creation or transfer of NFTS may be used to update the traditional database.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is an illustration of the method of the first embodiment of the invention for creating a plurality of tokens in a batch process.

FIG. 2 is a screenshot of a platform that may be used to create a batch of tokens using the principles of the embodiments of the invention.

FIG. 3 is a screenshot of the platform that may be used to create the batch of tokens, wherein the user inputs the number of tokens to create.

FIG. 4 is an illustration of the second embodiment of the invention wherein the batches may be split if transactional costs are low.

### DETAILED DESCRIPTION

Reference will now be made to the drawings in which the various embodiments of the present invention will be given numerical designations and in which the embodiments will be discussed so as to enable one skilled in the art to make and use the invention. It is to be understood that the following description illustrates embodiments of the present invention and should not be viewed as narrowing the claims which follow.

This document has explained that a non-fungible token or NFT is a unique token in the Ethereum blockchain. Creating tokens is a desirable action but it has currency costs. Specifically, the cost of the transaction is the cost of gas. For example, the cost of creating a single NFT may cost a few cents. While this is a reasonable cost when creating a few NFTs, the costs can be prohibitive when a much larger number of NFTs are to be created. For example, consider the user who wants to create 100,000 or 1,000,000 NFTs. The real currency costs can quickly exceed thousands of dollars.

It is desirable to have a method for creating a large number of NFTs at one time without spending the prohibitive cost of gas for each NFT created. The first embodiment of the invention describes a method of creating a large number of NFTs or tokens at one time. This method is referred to as batch minting. One of the most powerful features of the first embodiment is the ability of users to create a large number of digital collectibles (ERC-721 non-fungible tokens, aka NFTs) in a single transaction.

In order to decreases costs on a platform that costs money to run code, the present invention has determined that the ability to iterate within a smart contract completely may be removed from the system, and the ownership information may be stored in a traditional database while using a Fenwick tree approach to track ownership. Then events emitted on the creation and transfer of tokens may be used to update an ownership database. The traditional database may be referred to hereinafter as the ownership database because it is storing ownership data regarding the NFTs.

In Ethereum, the theoretical limit of NFTs that can be created may be 2\hat{ }255 tokens. This first embodiment adds on to the current available solutions for tracking NFTs using the ERC-721 standard because the ERC-721 standard cannot scale.

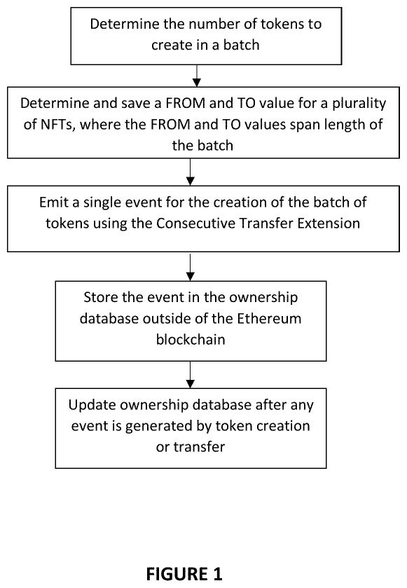

As shown in FIG. 1, a method for creating a plurality of NFTs is to batch mint a large number of tokens at one time in constant (O (1)) time begins by using the concept of batches. In a first step, the user may determine the number of tokens to be created.

Tokens have a unique identifier or token ID that is incremented sequentially. Based on the number of tokens to create, it is necessary to find a value representing a FROM value and a value representing a TO value within a sequential batch of tokens, with FROM being the beginning of the range of tokens to create and TO being the end of that range. Using sequential identifiers for each token, the FROM and TO values will span the length of the batch the user intends to create.

For example, if there had already been ten tokens created and it is desired to create ten more, the FROM value would be 11 and the TO value would be 20. The FROM value may then be saved as a node in a balanced binary tree structure.

Unfortunately, Ethereum is becoming bloated with data. As more data is stored in the Ethereum blockchain, the more expensive it becomes to create tokens, transfer tokens, burn tokens, and perform transactions. In addition, the more complex a program is, the more it costs to run on the Ethereum blockchain.

Accordingly, the first embodiment of the invention may store data for tracking ownership of NFTs outside of the Ethereum blockchain. This is because keeping track of ownership within a contract itself has now become relatively expensive to do.

The first embodiment of the invention may also be comprised of a method of tracking NFT ownership outside of the Ethereum blockchain. The method therefore includes the use of the ownership database on computers outside of the Ethereum blockchain. What is important to remember is that the Ethereum blockchain still includes all of the information that is necessary to reconstruct ownership of any NFT if necessary. Thus, it is possible to identify the creation of an NFT, and then identify each transaction where ownership was transferred. In other words, ownership information may be pieced together based on events that are recorded in the Ethereum blockchain.

One method of creating the ownership database is to record all of the events regarding creation, transfer of ownership, and burning of NFTs on the Ethereum blockchain. These events may be generated using a program on the Ethereum blockchain that generates notification of events.

The Ethereum blockchain now includes the EIP-2309 Consecutive Transfer Extension. The EIP-2309 Consecutive Transfer Extension is a standardized method in which decentralized applications may track ownership of a large number of NFTs.

For example, the Consecutive Transfer Extension may perform the next step in the method and be used to emit one event to track the creation or minting of a large batch of NFTs. The code for the batch creation and generation of an event could look like the following:

| | |
|---|---|
| 1 | function mint(unit amount, address from, address to) public{ |
| 2 | |
| 3 | // Create NFTs and assign ownership |
| 4 | // ... |
| 5 | // Emit Consecutive Transfer Event |
| 6 | emit ConsecutiveTransfer(lastMintedId + 1, lastMintedId + |
| | amount, from, to); |
| 7 | } |

The lastMintedId would be the last consecutive token that was created before this batch mint began. For example, lastMintedId would initially be 0. After creating the first NFT it would become 1. Then if five more NFTs were created, the range of NFTs created would be 2 to 6 and lastMintedId would be 6.

The Consecutive Transfer Extension was written to allow for the smallest change possible to the original ERC-721 specification while still providing a mechanism to track the creation, transfer, and burning of a large number of tokens.

It should be understood that while the term “large number of tokens” suggests some number much greater than two, the method of the batch minting may apply to as few as the creation of two tokens.

After emitting the event that the batch of NFTs was created, the final step is to record the event in the ownership database. The ownership database may be saved apart from the Ethereum blockchain and may be stored on one or more computers. Any party may host the ownership database and it will be publicly accessible.

It should be understood that any subsequent creation or transfer of tokens may also generate an event that is used to update the ownership database.

Alternatively, ownership of NFTs may always be reconstructed from the Ethereum blockchain itself. However, it would be more efficient to keep an up-to-date record of ownership history by simply recording the events generated by the Consecutive Transfer Extension as they occur instead of recreating the database each time that ownership information is needed. However, recreation of ownership data could be used to verify the accuracy of the ownership database. In addition, it may take a substantial amount of time to search for all relevant events on the Ethereum blockchain. The structure of the ownership database will be addressed later.

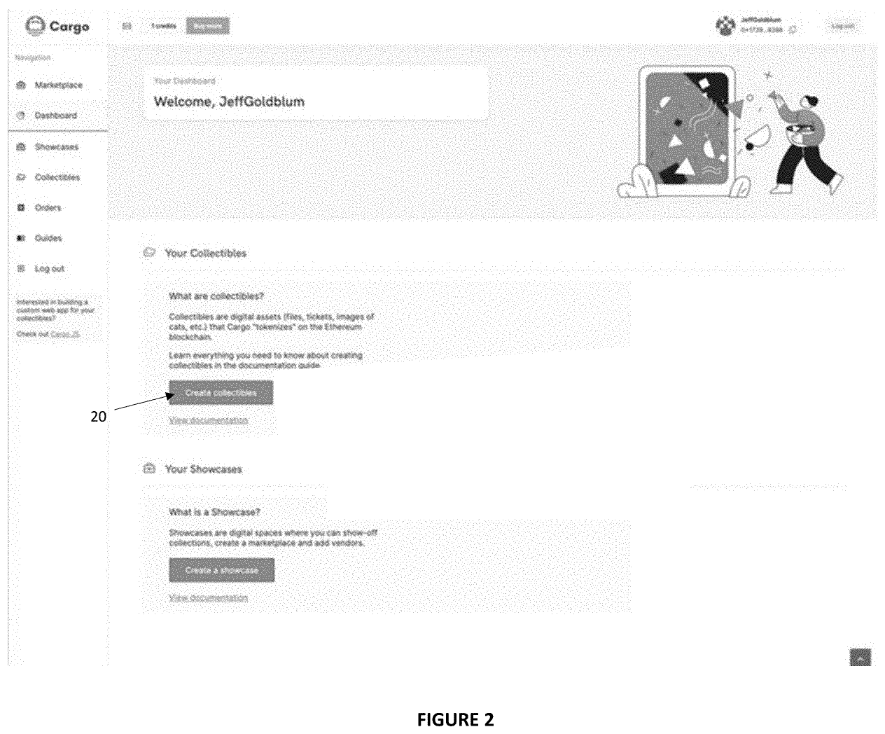

FIG. 2 is a screenshot of a service that uses the embodiments of the invention to create and transfer NFTs. Specifically, FIG. 2 shows a screenshot from a service called CARGO™. CARGO™ is a service for creating, storing, and selling digital collectibles. However, it should be understood that any service that creates and stores NFTs on the Ethereum blockchain may take advantage of the embodiments of the invention. Furthermore, any cryptocurrency platform may also take advantage of the teachings of the embodiments of the invention to enhance many aspects of token creation and transfer, especially when transactional costs or the costs of running complex programs are high.

The screenshot shown in FIG. 2 shows that the user clicks on the Create collectibles button 20 to create one or more NFTs.

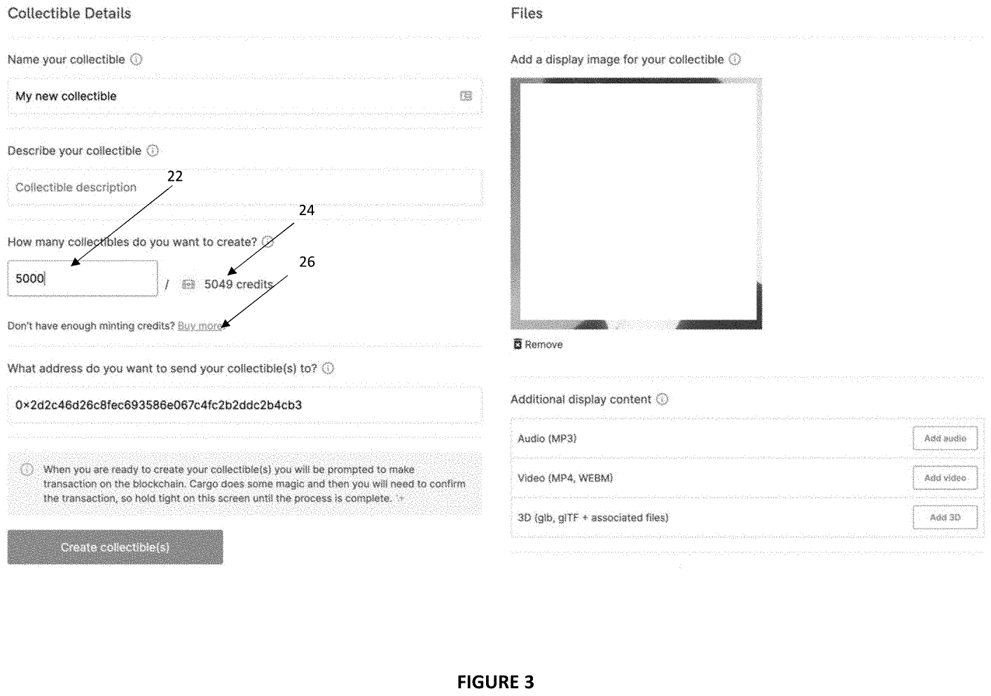

FIG. 3 is a screenshot that the user may see when using the CARGO™ service and has selected the option to create collectibles. The user enters the number of collectibles (NFTs) that the user wants to create in box 22. The user may also see the number of credits available 24 for creating collectibles, with one credit corresponding to the cost of each collectible. If the user has insufficient credits, the user is given the option of buying more credits by clicking on the Buy more button 26.

The details above are directed to the issue of the creation of tokens in the Ethereum blockchain. However, once tokens are created, they must be capable of being located in a timely manner. Thus, another aspect of the first embodiment is a method for searching for specific tokens or token IDs.

It was stated previously that in the first embodiment of the invention, the FROM value from a batch of tokens may be stored in a balanced binary tree such as a Fenwick tree. The balanced binary tree data structure provides an efficient means of finding a batch, or a batch containing a given token.

The FROM value may also be stored in a hash map so that data may be associated with the FROM value. This data may include such things as the associated TO value. The length (TO−FROM+1) may be stored in a Fenwick tree which allows the first embodiment to efficiently find an NFT at a given index.

It may then be possible to find a given token identifier (token ID) and determine which batch it is in and find whatever information is related to that batch in O(log n) time by using a balanced binary search tree, or any other data structure that will allow searching in O(log n) time.

The ERC-721 specification has an enumeration extension that enables users to iteratively loop over NFTs one at a time. The enumeration extension includes the values tokenOfOwnerByIndex, tokenByIndex, and totalSupply. It is understood that given the restraints of the Ethereum system and current solutions it may be difficult to create a list large enough to contain 2\hat{ }255 tokens which would be needed to get the index (position) of the 2\hat{ }255th token created within that list.

Accordingly, it may be possible to obtain the index of all tokens that have been created using this method in O (log n) time. This will support the enumeration extension for a large number, or 2\hat{ }255 of NFTs.

Obtaining an index value of a token may be done by storing the length of each batch in a Fenwick tree-type data structure. This tree makes it possible to obtain the prefix (or suffix) sum of a given index in O (log n) time. These values may also be updated in O (log n) time which is required when the number of tokens in a batch is changed.

For example, suppose there are one million batches, all of them having varying amounts of NFTs within them. A user wants to find the token at position 500,000 and imagining each token in the batches was stored individually in a linear list.

Using the Fenwick tree, it may be possible to perform a binary search to find the crossover point (the batch in which the token ID would fall into). In other words, the crossover point is not the batch, but rather the index in the Fenwick tree that has been determined to be the sum that is as large as it can be before becoming less than the index being searched for. Then that index is associated to a batch using a hash map.

Another ERC-721 extension is the metadata extension where a Uniform Resource Identifier (URI) is associated with a token ID. The first embodiment may include a way to store the host of the URI in a separate smart contract, thereby making the URI updatable, and saving the path to the metadata file in the NFT contract. In this way the host may be dynamically updated if it ever needed to be changed. This would then update every token contract ever created using this system.

For tokens created within batches, the path would include identifiable information about that token which could include the token address and the token ID and the host specified in the other contract would be responsible for returning dynamic or static metadata regarding that token ID.

Metadata for batches may be updated in O (1) time by using the standard method of storing metadata which is a mapping of token ID to metadata URI. Querying for token metadata would be O (1) if stored in the mapping, or O (log n) if it is necessary to search the batches to find the token ID.

In order to conserve transaction costs and avoid using gas, the first embodiment does not remove tokens from batches when ownership of a token is transferred, but instead keeps the batches intact as described above.

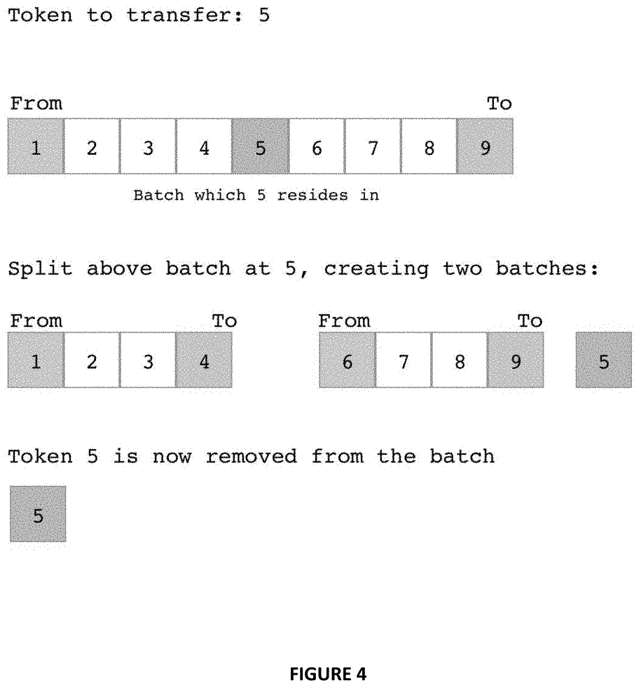

In contrast, in a second embodiment of the invention, tokens are removed from a batch when ownership is transferred. Transferring tokens from batches will result in splitting the batch into two batches at the transferred token as shown in FIG. 4, or it might include just updating either the FROM or the TO value. This would require updating the length of the batch in the Fenwick tree which allows updates in O (log n) time. In order to find which token to transfer from the batch, it is necessary to perform a binary search of the balanced binary tree in O (log n) time.

The FROM value is also saved into a data structure that will allow retrieval of other information, including the TO value, associated with the FROM value in constant time. This may be a hash map.

A data structure is then obtained that allows efficient computation of a suffix, or prefix sums and update values, wherein this could be a Fenwick tree, where the length (number of tokens within the batch) is stored. This data structure may hold duplicate lengths.

The index is then stored, and that value resides in a hash-map-like data structure, so it is possible to look up the FROM value. The FROM value is also saved in a hash-map-like data structure to look up at which index it resides in the Fenwick tree structure.

A possible example in code may be as follows:

mapping(fromValue => indexInFenwickTree)
mapping(indexInFenwickTree => fromValue)

The next step may be finding the data associated with a given token ID in a batch. Token identifiers are sequential numbers. In order to find data associated with a token within a batch, a binary search is performed on the balanced binary tree where the FROM values were stored. Based on the current FROM value, the TO value associated with it is located and can be found in constant time.

If the token identifier being searched for falls between the current FROM and TO value, then the token and data associated with it has been located. If not, the binary search of the data structure continues.

The next step may be to find a token by index position. In order to loop through tokens one at a time, the method of the first embodiment accepts the index position of the token in the list. This could be used to loop through tokens owned by a particular entity, or this could be used to loop through all the tokens that exist within the encapsulating system.

This list may be thought of as a linear list. For example, suppose a user owns the following tokens 1, 3, 4, 5, and 6. Given that most programming languages use a zero based index, index 0 would return 1. Index 1 would return 3. Index 3 would return 4 and so on. If a batch of ten thousand tokens was created, it is possible to iterate through them one at a time starting at the first position and ending at the last. In order to accomplish this, the lengths of each batch may be stored in a data structure that allows efficient computation of the suffix, or prefix sums and update values.

For example, a Fenwick tree may be used to accomplish this in O (log n) time. When a new batch is created the length is added, which is the number of tokens in the batch, to the data structure. Then when looking for the index within a batch, a binary search is performed of the Fenwick tree-type structure to compute the suffix or prefix sum at each position of the search.

If it is determined that the prefix or suffix sum at the given index in the Fenwick tree is as large as it can be before becoming less than the index we are searching for then the batch length in which the index resides has been successfully found. However, if the position of the batch length in our Fenwick tree is at the end (when computing suffix sums) or beginning (when computing prefix sums) then all that needs to be done is to find the FROM value that corresponds to that length and add the initial index that was being searched for to that value and return the value. Otherwise, the suffix (or prefix) sum is subtracted from the FROM value before the index is added which was being searched for and then return the value.

The method of the second embodiment described above may be described using pseudo code as follows:

Use an efficient search to find the index which represents the suffix or prefix sum that is as large as it can be before becoming smaller than the index that the method is trying to find.

If the position of the index that was found in step 1 is at the end (when computing suffix sums) or beginning (when computing prefix sums) then find the FROM value that corresponds to that length and add the initial index that was being searched for to that value. Otherwise, subtract the suffix (or prefix) sum from the FROM value before the index which was being searched for is added. This ends the pseudo code.

After batch creation of the NFTs, it may be necessary to transfer ownership of a token and/or remove the token from a batch. Each batch may have particular data associated with it. This information may include information about who owns the token.

To facilitate the transferring of ownership, or any other functionality that would require removing the token from a batch, a binary search is performed on the tree that stores the FROM values. For the current FROM value the associated TO value is identified. If the token identifier which is to be transferred falls within that range then the batch to which it belongs has been located. Otherwise, the search is continued until the batch in which it belongs has been identified. After finding the batch which the token resides in, the method proceeds as follows and refers to FIG. 4.

A first option is performed if the batch contains only one token, then the batch will be depleted after the transfer. In this case the FROM value may be removed from the balanced tree structure and the associated TO value is also removed. The number of total batches is decreased by one and the value at the index associated with the FROM value in our Fenwick tree is decreased by one.

However, in a second option, if the token identifier representing the token being transferred is equal to the FROM value, then the FROM value is removed from the balanced tree structure. The new FROM value will be the old FROM value plus one. The new FROM value is then inserted into the balanced tree structure the associated TO value is saved (along with any other data which may be associated with this batch). The new FROM value is stored in the Fenwick tree as the same position that the old FROM value resided. The index in the Fenwick tree is then mapped to the new FROM value. The value at the index in the Fenwick tree is then decreased by one, and then associated data is moved to the old FROM value.

In a third option, if the token identifier representing the token being transferred is equal to the TO value of the batch, then the new TO value becomes the old TO value minus one. The new TO value is associated to the current FROM value and the batch's value at the position in the Fenwick tree is decreased by one.

In a fourth option, if the token is within the FROM and TO value then the TO value is modified to create a new batch.

Another aspect of the present invention is the topic of batch transfer of tokens. Rather than splitting the batch, a token may be tracked in a map that uses the token ID as a key and the owner as a value. It would still be possible to batch transfer tokens using a loop setting multiple token IDs as keys and owners as values. This would only apply to tokens that were transferred. This can be done multiple times using a loop to support multiple token transfers.

After transferring one or many tokens, an event may be emitted from the Ethereum blockchain stating which tokens were transferred. A traditional web server could be listening for these events and could update the ownership database.

In summary, the first embodiment of the invention is a method for creating, tracking, and transferring a plurality of non-fungible tokens in a digital ledger using a batch mint process on a computing device, said method comprising determining a total number of non-fungible tokens to create using a batch mint process, wherein the total number is greater than one, entering the number of non-fungible tokens using a user interface associated with a user that provides access to the digital ledger on a blockchain network, creating the batch of non-fungible tokens in sequential order using the computing device on the blockchain network, and emitting a single event from the blockchain network when the batch of non-fungible tokens are created, wherein the single event indicates the total number of the batch of non-fungible tokens that were created.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A method for creating, tracking, and transferring a plurality of non-fungible tokens in a digital ledger using a batch mint process on a computing device, said method comprising:
determining a total number of non-fungible tokens to create using a batch mint process, wherein the total number is greater than one;
entering the number of non-fungible tokens using a user interface associated with a user that provides access to the digital ledger on a blockchain network;
creating the batch of non-fungible tokens in sequential order using the computing device on the blockchain network; and
emitting a single event from the blockchain network when the batch of non-fungible tokens are created, wherein the single event indicates the total number of the batch of non-fungible tokens that were created.

2. The method as defined in claim 1 wherein the method further comprises:
creating a traditional database regarding ownership of the non-fungible tokens in an ownership database, wherein the ownership database is stored on at least one computing device, and wherein the ownership database is not stored on the blockchain network; and
storing events in the ownership database that are emitted from the blockchain network regarding creation, transfer, and burning of non-fungible tokens to thereby maintain a record of ownership for all NFTs in the blockchain network.

3. The method as defined in claim 2 wherein the method further comprises:
providing a web server that looks for events from the blockchain network; and
updating the ownership database after each new event is generated by the blockchain network.

4. The method as defined in claim 3 wherein the method further comprises using the Consecutive Transfer Extension to generate the events from the blockchain network.

5. The method as defined in claim 1 wherein the method further comprises using the Ethereum platform as the blockchain network.

6. The method as defined in claim 1 wherein the step of creating the batch of non-fungible tokens in sequential order further comprises:
identifying a token identifier of a first token in the batch and assigning the first token as a FROM value; and
identifying a token identifier of a last token in the batch and assigning the last token as a TO value, wherein the value of the FROM token and the TO token span a length of the batch.

7. The method as defined in claim 1 wherein the step of using a user interface further comprises accessing the blockchain network using a platform that enables access, such as the CARGO™ platform.

8. The method as defined in claim 1 wherein the method further comprises searching for a specific non-fungible token in the blockchain network, said method comprising:
storing the FROM value of a new batch of non-fungible tokens as a node in a balanced binary tree data structure;
storing data associated with the FROM value in a different data structure;
keeping the batches complete even when tokens are transferred to a different user; and
searching the balanced binary tree data structure to locate a batch of tokens or a batch containing a given token.

9. The method as defined in claim 8 wherein the method further comprises using a path to obtain identifiable information about tokens created within a batch, wherein the identifiable information may include a token address and a token ID.

10. The method as defined in claim 1 wherein the method further comprises searching for a specific non-fungible token in the blockchain network, said method comprising:
storing the FROM value of a new batch of non-fungible tokens as a node in a balanced binary tree data structure;
storing data associated with the FROM value in a hash map;
splitting the batches whenever ownership of one or more tokens in a batch are transferred; and
searching the balanced binary tree data structure to locate a batch of tokens or a batch containing a given token.

11. The method as defined in claim 1 wherein the method further comprises transferring a plurality of tokens, said method comprising:
assigning a token ID as a key and an owner as a value in a data structure; and
performing a batch transfer of non-fungible tokens using a loop sequence.

12. A method for creating, tracking, and transferring a plurality of non-fungible tokens in the Ethereum blockchain network using a batch mint process on a computing device, said method comprising:
determining a total number of non-fungible tokens to create using a batch mint process, wherein the total number is greater than one;
entering the number of non-fungible tokens using a user interface associated with a user that provides access to the Ethereum blockchain network;
creating the batch of non-fungible tokens in sequential order using the computing device on the Ethereum blockchain network;
emitting a single event from the Ethereum blockchain network when the batch of non-fungible tokens are created, wherein the single event indicates the total number of the batch of non-fungible tokens that were created;
creating a database regarding ownership of the non-fungible tokens in an ownership database, wherein the ownership database is stored on at least one computing device, and wherein the ownership database is not stored on the blockchain network; and
storing events in the ownership database that are emitted from the blockchain network regarding creation, transfer, and burning of non-fungible tokens to thereby maintain a record of ownership for all NFTs in the blockchain network.

13. The method as defined in claim 12 wherein the method further comprises:
providing a web server that looks for events from the blockchain network; and
updating the ownership database after each new event is generated by the blockchain network.

14. The method as defined in claim 13 wherein the method further comprises using the Consecutive Transfer Extension to generate the events from the blockchain network.

15. The method as defined in claim 12 wherein the method further comprises using the Ethereum platform as the blockchain network.

16. The method as defined in claim 12 wherein the step of creating the batch of non-fungible tokens in sequential order further comprises:
identifying a token identifier of a first token in the batch and assigning the first token as a FROM value; and
identifying a token identifier of a last token in the batch and assigning the last token as a TO value, wherein the value of the FROM token and the TO token span a length of the batch.

17. The method as defined in claim 12 wherein the step of using a user interface further comprises accessing the blockchain network using a platform that enables access, such as the CARGO™ platform.

18. The method as defined in claim 12 wherein the method further comprises searching for a specific non-fungible token in the blockchain network, said method comprising:
storing the FROM value of a new batch of non-fungible tokens as a node in a balanced binary tree data structure;
storing data associated with the FROM value in a hash map;
keeping the batches complete even when tokens are transferred to a different user; and
searching the balanced binary tree data structure to locate a batch of tokens or a batch containing a given token.

19. The method as defined in claim 18 wherein the method further comprises using a path to obtain identifiable information about tokens created within a batch, wherein the identifiable information may include a token address and a token ID.

20. The method as defined in claim 12 wherein the method further comprises searching for a specific non-fungible token in the blockchain network, said method comprising:
storing the FROM value of a new batch of non-fungible tokens as a node in a balanced binary tree data structure;
storing data associated with the FROM value in a hash map;
splitting the batches whenever ownership of one or more tokens in a batch are transferred; and
searching the balanced binary tree data structure to locate a batch of tokens or a batch containing a given token.
